(19) United States
(12) Patent Application Publication
(10) Pub. No.: US 2026/0218477 A1
(43) Pub. Date: Jul. 30, 2026

(54) Self-repairing capsule for landfill liner and method for preventing leakage

(71) Applicants: Shanghai Investigation, Design & Research Institute Co., Ltd., Shanghai (CN); BeSTDR Infrastructure Hospital (Pingyu), Zhumadian (CN)

(72) Inventors: Fuming WANG, Shanghai (CN); Dongkun LIU, Shanghai (CN); Xiao WANG, Shanghai (CN); Zhenzhen LIN, Shanghai (CN); Pengcheng ZHANG, Shanghai (CN); Qiuju KE, Shanghai (CN); Chengchao GUO, Shanghai (CN); Feng FU, Shanghai (CN); Benli LOU, Shanghai (CN); Bingbing XIA, Shanghai (CN); Zhen ZHANG, Shanghai (CN); Bo LAN, Shanghai (CN); Zheng ZHU, Shanghai (CN); Heng LU, Shanghai (CN)

(73) Assignees: Shanghai Investigation, Design & Research Institute Co., Ltd., Shanghai (CN); BeSTDR Infrastructure Hospital (Pingyu), Zhumadian (CN)

(21) Appl. No.: 18/697,486

(22) PCT Filed: Oct. 11, 2023
(86) PCT No.: PCT/CN2023/124085

§ 371 Date: Apr. 17, 2026

(30) Foreign Application Priority Data
Jul. 31, 2023 (CN) 202310947401.7

(51) Int. Cl. E02D 31/00; E02D 31/04

(52) U.S. Cl. CPC E02D 31/004; E02D 31/04

(57) ABSTRACT

The present invention provides a self-repairing capsule for landfill liner and a method for preventing leakage, including: a capsule shell, which has a foaming reaction chamber inside and multiple through-holes connected to the foaming reaction chamber; a foam-generating assembly designed for producing foaming material, contained within the foaming reaction chamber, and closely-packed with multiple grouting strips; a water vapor barrier layer, attached to the capsule shell and covering the multiple through-holes; and an adhesive coated on the capsule shell outside the multiple through-holes just before the foam-generating foaming assembly is soaked in the leachate of the landfill. Then different foaming liquids mix to form foaming material after the respective grouting strips dissolve. The technique solves the problem of delayed detection of pollution leakage in landfill and grouting repair at its deep bottom.

### FIELD OF THE INVENTION

The present invention relates to the field of solid waste treatment technology, especially relates to a self-repairing capsule for landfill liners and a method for preventing pollutant leakage.

### BACKGROUND OF THE INVENTION.

Disasters occurred at landfills are mainly caused by leachate leakage, which causes serious pollution, so an impermeable design is extremely important at the beginning of landfill construction. At the same time, it is also crucial to deal with the leakage promptly after it occurs. Currently, the landfill liner mainly consists of waterproofing membranes and natural soil layers, with leakage holes set up to monitor the leakage conditions.

However, due to the hidden nature of the leakage, significant pollution has often already occurred by the time the leakage is discovered, making it difficult to seal off. In particular, the central position at the bottom of the landfill is relatively deep, it is difficult to support heavy grouting equipment to dig from above the overlying landfill, so repairing the leakage is a challenge.

### SUMMARY OF THE INVENTION

The present invention is to provide a self-repairing capsule for landfill liners and a method for preventing chemical leakage, the capsule can trigger formation of foaming material to fill voids between two impermeable membranes, when the leachate permeates into the landfill liner. By optimizing and repairing the impermeable structure of the landfill, the problem of pollution caused by delayed detection of leakage can be resolved, and the challenging issue of grouting repair in the deep bottom layer of the landfill can be effectively addressed, which is more conducive to environmental protection.

The present invention provides a self-repairing capsule for the landfill liner, including:
a capsule shell, enclosing a foaming reaction chamber, and multiple through-holes connected to the foaming reaction chamber;
a foam-generating assembly designed for producing foaming material, the assembly is contained within the foaming reaction chamber, and includes multiple grouting strips disposed closely together. The grouting strips are made of water-soluble films, and different grouting strips contain different foaming liquids;
a water vapor barrier layer, which is attached to the capsule shell and covers the multiple through-holes; and
an adhesive component provided on the part of the capsule shell where multiple through-holes are not arranged at, the adhesive component attaches the capsule shell to an impermeable membrane of the landfill liner.

When the foam-generating foaming assembly is soaked in the leachate of the landfill, different foaming liquids mix together to form a foaming material after the respective relevant grouting strips dissolve in the leachate. The foaming material expands and fills the void areas of the landfill liner via the multiple through-holes after pressure is applied to push away the water vapor barrier layer.

Preferably, the multiple through-holes include an open hole at both ends of the capsule shell and/or multiple pierced holes on the outer peripheral wall of the capsule shell.

Preferably, the pierced holes are evenly distributed in the upper half of the capsule shell when placed horizontally, while the adhesive component is located in the lower half of the capsule shell.

Preferably, the adhesive component is a rubber strip, which is set at the bottom of the capsule shell and extends horizontally when the capsule shell is placed horizontally.

Preferably, the number of the grouting strips is two, one of the two contains component A while the other contains component B, A and B have different liquids.

Preferably, the two grouting strips spiral and intertwine along the length direction of the capsule shell.

Preferably, the water-soluble films are made of polyvinyl alcohol (PVA) material.

Preferably, the water vapor barrier layer is made of absorbent cotton pads.

Preferably, the capsule shell is made of polyvinyl chloride (PVC)material.

The present invention also provides a method for applying the self-repairing capsules in landfill liner to prevent leakage, the method includes the following steps:
based on the geological conditions of the area where the landfill liner is located, setting the quantity parameters and spacing parameters of the self-repairing capsules to be placed between two impermeable membranes;
placing multiple self-repairing capsules horizontally in an arrayed distribution between the two impermeable membranes, adhering each self-repairing capsule to the lower impermeable membrane, with an opening direction of the multiple pierced holes neither directly downward nor diagonally downward, where the opening direction refers to the direction extending from the interior of the capsule shell through the pierced holes towards the exterior of the capsule shell.

As described above, the self-repairing capsule in landfill liner and method for leakage prevention of the present invention has the following beneficial effects: based on the structure of the landfill liner, the present invention designs a self-repairing capsule for the landfill liner. The self-repairing capsule can produce foaming material, which can fill the voids in the landfill liner, thereby forming a new impermeable structure, to improve impermeability, thereby achieving prevention, initial leakage treatment, and minimized pollution. The principle of leakage prevention by the self-repairing capsule is as follows: the capsule shell encloses a foaming reaction chamber, which facilitates the mixing and reaction of different foaming liquids to form a foaming material in a large number of fine void structures. The capsule shell has multiple through-holes connected to the foaming reaction chamber. The multiple through-holes allow the foaming material produced in the foaming reaction chamber expand and overflow to the capsule shell via the holes, thereby filling the voids in the landfill liner. The foam-generating assembly includes multiple grouting strips disposed closely together and the grouting strips are made of water-soluble films. Different grouting strips contain different foaming liquids, but none of the foaming liquids contain water. When the foam-generating assembly is soaked in the leachate of the landfill, different foaming liquids mix up to form a foaming material after the respective grouting strips dissolve. The water vapor barrier layer is attached to the capsule shell to cover the multiple through-holes, so as to resist the water vapor flowing between the two impermeable membranes, thus water vapor is prevented from entering the foaming reaction chamber. In other words, the water vapor barrier layer has the characteristic of being impermeable to water vapor, so only the leachate can penetrate into the foaming reaction chamber, dissolve the grouting strips and produce the foaming material. The adhesive component adheres the part of the capsule shell without through-holes to the impermeable membrane in the landfill liner. This arrangement prevents the capsule shell from creating leakage-prone points that deviate from the landfill liner on the impermeable membrane, thereby ensuring the correct release points of the foaming material. Finally, after filling the void areas of the landfill liner with the foaming material, the foam material can solidify and form a dense, effective impermeable structure after a predetermined time. Therefore, the self-repairing capsule of the landfill liner in the present invention can trigger the foaming material to fill the voids between two impermeable membranes when the leachate permeates into the landfill liner. By optimizing and repairing the landfill's impermeable structure, the pollution caused by delayed detection of leakage can be resolved, and the challenging issue of grouting repair in the deep bottom layer of the landfill can be effectively addressed, which is more conducive to environmental protection.

### BRIEF DESCRIPTION OF DRAWINGS

FIG. 1 shows a perspective view of a self-repairing capsule for a landfill liner according to the present invention;

FIG. 2 shows the diagram of a capsule shell and a foaming assembly;

FIG. 3 shows another perspective view of a capsule shell; and

FIG. 4 shows another perspective view of a foaming assembly.

### DESCRIPTION OF COMPONENT LABELING

1 Capsule shell
11 Foaming reaction chamber
12 Open hole
13 Pierced hole
2 Foam-generating assembly
21 Grouting strip
3 Water vapor barrier layer
4 Adhesive component

### DETAILED DESCRIPTION

The specific embodiments are described below to illustrate the implementation of the present invention, and those skilled in the art can easily understand other advantages and effects of the present invention from the disclosure in this specification.

It should be understood that the structures, proportions, sizes, and the like, which are illustrated in the drawings of the present specification, are only used to clarify the contents disclosed in the specification for understanding and reading by those skilled, and are not intended to limit the implementation of the present disclosure, thus are not technically meaningful. Any modification of the structure, change of the scale, or adjustment of the size should still fall within the scope of the technical contents disclosed by the present disclosure without affecting the effects and achievable objectives of the present disclosure. In the meantime, the terms “upper”, “lower”, “left”, “right”, “intermediate” and “one” as used in this specification are also for the convenience of description, and are not intended to limit the scope of the present disclosure, and the change or adjustment of the relative relationship is considered to be within the scope of the present disclosure without substantial changes in technology.

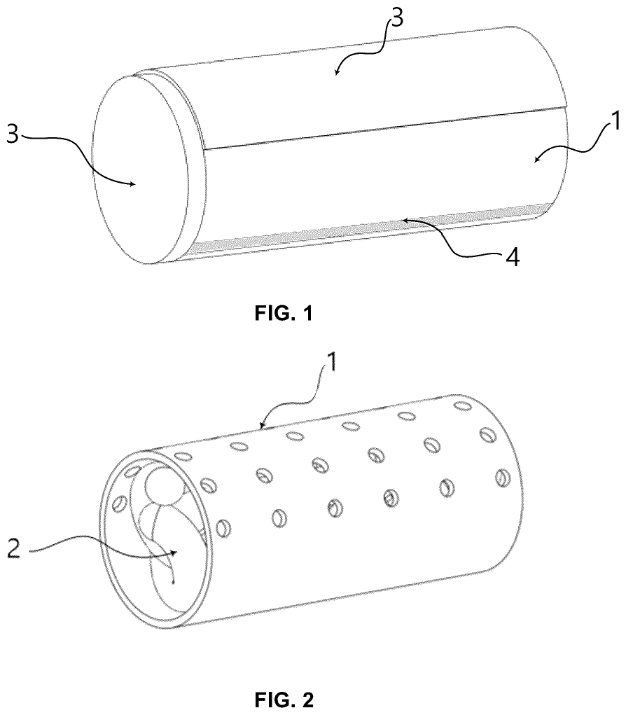

As shown in FIGS. 1, 2, 3, and 4, the present invention provides a self-repairing capsule used in landfill liner, including:
a capsule shell 1, which contains a foaming reaction chamber 11 inside and multiple through-holes connected to the foaming reaction chamber 11;
a foam-generating assembly 2 designed for producing foaming material, the assembly is contained within the foaming reaction chamber 11, and includes multiple grouting strips 21 disposed closely together around the central cylindrical axis of the chamber. The grouting strips 21 are made of water-soluble films, and different grouting strips 21 contain different foaming liquids;
a water vapor barrier layer 3, which is attached to the capsule shell 1 and covers the multiple through-holes; and
an adhesive component 4 provided on the part of the capsule shell 1 without the through-holes, to the adhesive component 4 adheres the capsule shell 1 to an impermeable membrane of the landfill liner.

When the foam-generating foaming assembly 2 is soaked in the leachate from the landfill, different foaming liquids mix to generate a foaming material after the respective grouting strips 21 dissolve. The foaming material expands and fills the void areas of the landfill liner through the multiple through-holes after applying pressure to push away the water vapor barrier layer 3.

Based on the structure of the landfill liner, the present invention designs a self-repairing capsule for the landfill liner. The self-repairing capsule can produce a foaming material, which can fill the voids in the landfill liner, thereby improving the impermeable structure, the new landfill liner has better impermeability, achieving prevention and initial leakage treatment, and minimum pollution. The principle of leakage prevention of the self-repairing capsule is as follows:

The capsule shell 1 contains a foaming reaction chamber 11, which facilitates the mixing and reaction of different foaming liquids in a large number of fine voids to generate a foaming material. The capsule shell 1 has multiple through-holes, connected to the foaming reaction chamber 11, allowing the foaming material produced in the foaming reaction chamber 11 to expand and overflow to the capsule shell 1 through the multiple through-holes, thereby filling the voids in the landfill liner. The foam-generating assembly 2 includes multiple grouting strips 21 disposed closely together. The grouting strips 21 are made of water-soluble films. Different grouting strips contain different foaming liquids, but none of the foaming liquids contains water. When the foam-generating assembly 2 is soaked in the leachate of the landfill, different foaming liquids mix to generate a foaming material after the respective grouting strips 21 dissolve. The water vapor barrier layer 3 is attached to the capsule shell 1 and covers the multiple through-hole, this water vapor barrier layer 3 resists water vapor flowing between the two impermeable membranes, so as to prevent water vapor from entering the foaming reaction chamber 11. In other words, the water vapor barrier layer 3 has the characteristic of being impermeable to water vapor, ensuring that only the leachate (which is generally alkaline and contains chloride ions or sulfate ions) can penetrate the foaming reaction chamber 11, thereby causing the grouting strips 21 to dissolve and produce foaming material. The adhesive component 4 attaches the part of capsule shell 1 outside the multiple through-holes to the impermeable membrane of the landfill liner, which can prevent capsule shell 1 from creating leakage-prone points that deviate from the landfill liner on the impermeable membrane, thereby ensuring the correct release points of the foaming material. Finally, after filling the void areas of the landfill liner with the foaming material, the foam material can solidify and form a dense, effective impermeable structure after a predetermined time.

Therefore, the self-repairing capsule for the landfill liner in the present invention can lead the foaming material to fill the voids between the two impermeable membranes when the leachate infiltrates the landfill liner. By optimizing and repairing the landfill's impermeable structure, the pollution caused by delayed detection of leakage can be resolved, and the challenging issue of grouting repair in the deep bottom layer of the landfill can be effectively addressed, which is more conducive to environmental protection.

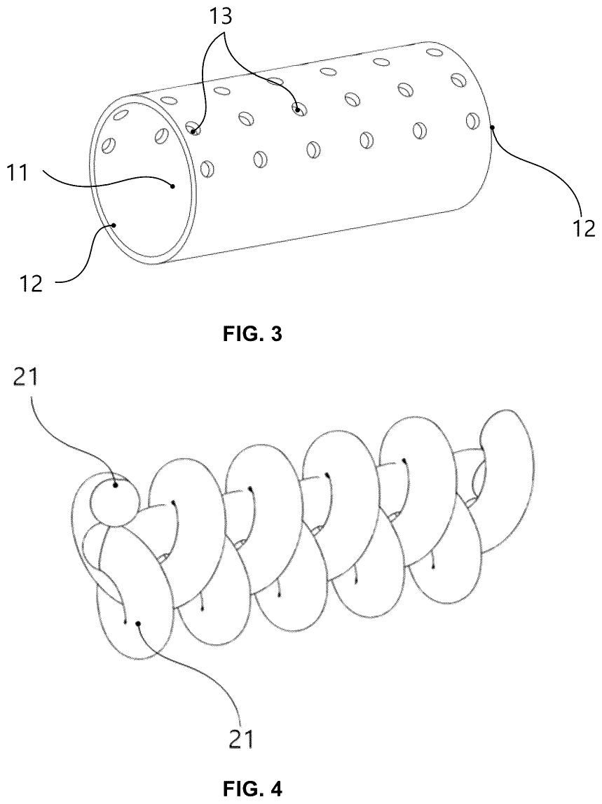

As shown in FIG. 3, to facilitate the leachate to flow into the foaming reaction chamber 11 of the capsule shell 1 and to fill the void areas of the landfill liner more uniformly in different directions, the multiple through-holes include a few options: an open hole 12 at both ends of the capsule shell 1, and/or multiple pierced-holes 13 on the outer peripheral wall of the capsule shell 1. Specifically, capsule shell 1 is a hollow cylindrical structure, and both ends of capsule shell 1 have open-holes 12, that is, the foaming reaction chamber 11 of capsule shell 1 is a straight through structure.

To spill the foaming material towards the top and facilitate the foaming material to adhere to the leakage-prone points of the upper impermeable membrane, all the pierced holes 13 are evenly placed horizontally in the upper half of the capsule shell 1, while the adhesive component 4 is located in the lower half of the capsule shell 1.

As shown in FIG. 1, to reduce the bonding area between the adhesive component 4 and the lower impermeable membrane, the adhesive component 4 is a rubber strip, which is set at the bottom of the capsule shell 1 and extends horizontally when the capsule shell 1 is placed horizontally.

Since the foaming material is usually produced by mixing and reacting polyurethane foaming liquids, the number of the grouting strips 21 is two, one of which contains component A while the other contains component B.

In FIG. 4, to ensure a higher degree of mixing of components A and B after the dissolution of the damaged grouting strips 21, the two grouting strips 21 are arranged to be spiral and intertwine along the length direction of the capsule shell 1.

Due to the generally alkaline nature of leachates, leakage will directly create a soaking environment. Therefore, the water-soluble films are made of PVA materials. Currently, the reinforced PVA water-soluble films can be customized, with a thickness of about 2 mm and tensile strength of about 0.5 MPa, so as to ensure that the release of foaming liquid is only possible when soaked with leachate.

To reduce the manufacturing cost, the water vapor barrier layer 3 is made of absorbent cotton pads.

To allow for a slight expansion in the capsule shell 1's volume. To reduce the manufacturing cost, capsule shell 1 is made of PVC material.

The present invention also provides a method for preventing leakage using the self-repairing capsule for landfill liner, including the following steps:

Based on the geological conditions of the area where the landfill liner is located, the self-repairing capsules are placed between two impermeable membranes with proper quantity parameters and spacing parameters.

Multiple self-repairing capsules are horizontally placed in an arrayed distribution between two impermeable membranes, each self-repairing capsule is adhered to the lower impermeable membrane, with an opening direction of the multiple pierced holes neither directly downward nor diagonally downward, where the opening direction refers to the direction extending from the interior of the capsule shell through the pierced holes towards the exterior of the capsule shell.

Furthermore, the number of the impermeable membraners is two or more. To further improve the leakage prevention effect, the expansion ratio of the foaming material relative to the foaming liquid decreases as the water pressure value of the geological condition increases.

The leakage prevention method of the present invention can improve the anti-leakage function of the landfill liner.

Specifically, one of the real applications of the leakage prevention method in this disclosure can be for an existing dam, where self-healing capsules are bonded between the upper and lower adjacent layers of the impermeable membranes in the landfill liner, and the water vapor barrier layer 3 is arranged on the side of the capsule shell 1 facing the inside of the dam body, which can achieve the effect of preventing and sealing small leakage points, and can be custom designed for the quantity and density based on regional geological conditions, especially for vulnerable areas. The foaming material can be a polymer foaming material, and the expansion ratio of the polymer foaming material can be adjusted as needed under different geological conditions, with an expansion ratio of 5-20 times. In high water pressure areas (above 1 MPa), the ratio is 5 times, in medium water pressure areas (1-0.5 MPa), the ratio is around 10 times, and in low water pressure areas (below 0.5 MPa), the ratio is 20 times. The diameter of capsule shell 1 is 5 cm, the length of capsule shell 1 is 10 cm, and the slurry volume of the foaming assembly 2 is 0.2 kg. According to experiments, the expansion diffusion range of the foaming assembly 2 between geomembranes (the geomembrane is one of the specific embodiments of the impermeable membrane) is 0.2-0.4 cm, so the spacing of the self-repairing capsules should be between 0.2-0.6 m, and can be adjusted as needed. A high expansion ratio can directly seal a larger area, effectively sealing the leakage points in the early stage of leakage, especially for small leakage points.

In summary, the present invention enables a foaming material to fill the voids between the two impermeable membranes when the leachate infiltrates the impermeable layer of the landfill. By optimizing and repairing the landfill's impermeable structure, the pollution caused by delayed detection of leakage can be resolved, and the challenging issue of grouting repair in the deep bottom layer of the landfill can be effectively addressed, which is more conducive to environmental protection. Therefore, the present invention effectively overcomes various shortcomings in the existing means and has a high value in industrial utilization.

The preferred embodiments of the present disclosure are discussed above but is not used to limit the present disclosure. The person skilled in the art can make various amendments or modification to the present disclosure. Any modification, equivalent replacement, improvement, etc. made within the spirit and principle of the present disclosure shall be within the protection scope of the present disclosure.

1. A self-repairing capsule for landfill liner, comprising:
a capsule shell (1), which contains a foaming reaction chamber (11) inside and a plurality of through-holes connected to the foaming reaction chamber (11);
a foam-generating assembly (2), capable of generating a foaming material in the foaming reaction chamber (11), wherein the foam-generating assembly (2) comprises a plurality of grouting strips (21) disposed closely together, wherein the grouting strips (21) are made of water-soluble films, and wherein different grouting strips (21) comprise different foaming liquids, wherein the foaming liquids do not contain water;
a water vapor barrier layer (3), which is attached to the capsule shell (1) and covers the plurality of through-holes; and
an adhesive component (4), which is placed on a part of the capsule shell (1) outside the plurality of through-holes, wherein the adhesive component (4) attaches the capsule shell (1) to an impermeable membrane of the landfill liner;
wherein when the foam-generating assembly (2) is soaked in a leachate of the landfill, different foaming liquids mix to generate the foaming material after the grouting strips (21) dissolve, wherein the foaming material expands through the plurality of through-holes, applies a pressure to push away the water vapor barrier layer (3), and fills void areas of the landfill liner;
wherein a number of grouting strips (21) is two, one of the two grouting strips (21) is filled with a component A, while another of the grouting strips (21) is filled with component B; wherein the two grouting strips (21) spiral and intertwine along the length direction of the capsule shell (1); and
wherein the plurality of through-holes comprises an open hole (12) at both ends of the capsule shell (1) and/or a plurality of pierced holes (13) opened on an outer wall of the capsule shell (1), wherein the pierced holes (13) are evenly placed horizontally in an upper half of the capsule shell (1), while the adhesive component

(4) is placed in a lower half of the capsule shell (1).

2. The self-repairing capsule according to claim 1, wherein the adhesive component (4) comprises a rubber strip, wherein the rubber strip is set at a bottom of the capsule shell (1) and extends horizontally when the capsule shell (1) is placed horizontally.

3. The self-repairing capsule according to claim 1, wherein the water-soluble films are made from a PVA material.

4. The self-repairing capsule according to claim 1, wherein the water vapor barrier layer (3) comprises absorbent cotton pads.

5. The self-repairing capsule according to claim 1, wherein the capsule shell (1) further comprises a PVC material.

6. A method for using the self-repairing capsule to prevent leakage from the landfill liner as claimed in claim 1, comprising following steps:
based on area geological conditions where the landfill liner is located, setting quantity parameters and spacing parameters of the self-repairing capsules placed between two impermeable membranes; and
placing a plurality of self-repairing capsules horizontally in an arrayed distribution between the two impermeable membranes, adhering each of the plurality of self-repairing capsules to a lower impermeable membrane of the two, and ensuring that an opening direction of each of the plurality of pierced holes (13) is neither directly downward nor diagonally downward, wherein the opening direction refers to the direction extending from the interior of the capsule shell (1) through the plurality of pierced holes (13) towards the exterior of the capsule shell (1).
